(19) United States
(12) Patent Application Publication
(10) Pub. No.: US 2007/0234296 A1
(43) Pub. Date: Oct. 4, 2007

(54) Software variation for robustness through randomized execution contexts

(75) Inventors: Benjamin G. Zorn, Woodinville, WA (US); Emery Berger, Amherst, MA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/395,631

(22) Filed: Mar. 31, 2006

(51) Int. Cl. G06F 9/44

(52) U.S. Cl. 717/124

(57) ABSTRACT

Improved robustness of software program executions is achieved via randomization of their execution contexts. For instance, errors related to runtime allocation of memory on the heap can be probabilistically addressed by generating an approximation of the infinite heap and using a randomized memory manager to allocate memory on the heap. In addition to stand alone randomization, several replicas of a software program are executed, each with a memory manager configured with different randomization seeds for randomly allocating memory on an approximation of an infinite heap. Outputs of correctly executing instances of the replicas are determined by accepting the output that at least two of the replicas agree upon.

### TECHNICAL FIELD

The technology relates to improving reliability of software programs. More particularly, the field relates to achieving improved robustness of software through execution of the software in randomized execution contexts.

### BACKGROUND

Applications written in unsafe languages like C and C++ are vulnerable to many types of errors. In particular, these programs are vulnerable to memory management errors, such as buffer overflows, dangling pointers, and reads of uninitialized data. Such errors can lead to program crashes, security vulnerabilities, and unpredictable behavior. While many safe languages are now in wide use, a good number of installed software applications in use today are written in unsafe languages, such as C and C++. These languages allow programmers to maximize performance by providing greater control over such operations as memory allocation, but they are also error-prone.

The existing paradigm for improved software robustness generally seeks to pinpoint the location of the errors in a program by extensive testing and then fixing the identified errors. The effectiveness of this paradigm, however, is subject to the effectiveness of the testing regime and requires changes to the code. Moreover, even extensively tested programs can fail in the field once they are deployed.

For instance, memory management errors at runtime are especially troublesome. Dynamic memory allocation is the allocation of memory storage for use in a computer program during the runtime of that program. It is a way of distributing ownership of limited memory resources among many pieces of data and code. A dynamically allocated object remains allocated until it is deallocated, either explicitly by the programmer or automatically by a garbage collector. In heap-based dynamic memory allocation, memory is allocated from a large pool of unused memory area called the heap. The size of the memory allocation can be determined at runtime, and the lifetime of the allocation is not dependent on the current procedure or stack frame. The region of allocated memory is accessed indirectly, usually via a reference.

The basic functions of heap memory management by a memory allocator in the C language in a runtime system includes Malloc( ) for allocating an address on the heap to an object and Free( ) for freeing the object (or in other words, de-allocating). Although this appears to be simple, programming errors related to runtime memory management generate several well-known errors, which can be categorized as follows:

Dangling pointers: If a live object is freed prematurely, the memory allocator may overwrite its contents on the heap with a new object or heap metadata.

Buffer overflows: Out-of-bounds writes to heap can overwrite live objects on the heap, thus corrupting their contents.

Heap metadata overwrites: If heap metadata is stored too near heap objects, it can also be corrupted by buffer overflows.

Uninitialized reads: Reading values from newly-allocated memory leads to undefined behavior.

Invalid frees: Passing illegal addresses to Free( ) can corrupt the heap or lead to undefined behaviour.

Double frees: Repeated calls to Free( ) of objects that have already been freed undermine the integrity of freelist-based allocators.

Tools like Purify by IBM Rational and Valgrind, an open source debugger for Linux, allow programmers to pinpoint the exact location of some of these memory errors. However, they result in a significant increase in running time and are generally restricted in their use to the testing phase. Thus, deployed programs remain vulnerable to crashes or attack. Moreover, these tools may require changes to the code. Conservative garbage collectors can, at the cost of increased runtime and additional memory, disable calls to free( ) and so eliminate three of the above errors (e.g., invalid frees, double frees, and dangling pointers). Furthermore, assuming that the source code is available, a programmer can also compile the code with a safe C compiler that inserts dynamic checks for the remaining errors. This solution also results in further increasing the running time and requires changes to the program code. Furthermore, as soon as an error is detected, the inserted code aborts the execution of the program. Aborting a computation is often undesirable. Recognizing this need, some runtime systems sacrifice soundness in order to prolong execution, even in the face of memory errors. For example, some failure-oblivious computing solutions build on a safe C compiler, but drop illegal writes and manufactures values for invalid reads. Unfortunately, these systems cannot provide a probabilistic assurance to programmers that their programs are executing correctly.

Thus, it is desirable to improve robustness of a software program without the need to change the program's code. It is further desirable to determine to a given probabilistic level of certainty, the robustness of a software program.

### SUMMARY

Described herein are methods and systems for improving robustness of software by executing the software within randomized execution contexts. The execution context comprises randomized configurations of stack layouts and randomized configurations of runtime heap layouts, which are error tolerant. In one aspect, plurality of replicas of an executing program is executed, each within a randomly different execution context. As such, it is likely that at least some of the replicas will be executing within execution contexts that are error tolerant. Outputs of the replicas executing within error tolerant execution contexts are accepted as corresponding to the output of a correctly executing instance of the software program.

In one aspect, the error tolerant execution contexts are identified by determining at least two replicas and their corresponding randomized execution contexts that yield outputs that agree.

In one aspect, execution context comprises an error tolerant runtime heap layout which is made error tolerant by configuring it to approximate the semantics of an infinite heap. For instance, the infinite heap semantics can be approximated to known degrees of probability by expanding, (e.g., by an order of a multiple), the heap size required for a program assuming perfect packing of its objects. The expansion factor multiple can be any number and the approximated infinite heap can be a multiple of the perfectly packed heap itself or some approximation thereof.

In a further aspect, memory errors can be avoided by randomly allocating memory on the approximation of the infinite heap. For instance, upon receiving a request to allocate memory, a random number is generated. Then, some address on the approximated infinite heap that is based on the generated random number is identified and, if unallocated, it is allocated to the object associated with the current request. In another aspect, the allocation on the approximated infinite heap is based at least in part on the size of the memory requested. For instance, the approximated infinite heap is subdivided into different page sets with each set dedicated to objects of a specific size. The requests as such are then first mapped to a page based at least in part on the size of their object.

Chances of generating an ideal runtime execution environment that masks errors can be improved by executing a plurality of replicas of a program. For instance, plurality of replicas of a program are executed with different randomization seeds correspondingly associated therewith for randomly allocating memory on their respective approximations of the infinite heap. To detect uninitialized memory reads, each of the infinite heap approximations are initialized with randomly generated values, wherein the random values for each different heap are generated by use of its associated randomization seed. In a further aspect, outputs of those replicas that agree are accepted as the output of a correctly executing program instance. In one aspect, the replicas whose outputs do not agree with the others are terminated and another replica may be used to replace the terminated replica a copy of a non-terminated replica with a different randomization seed.

Additional features and advantages will become apparent from the following detailed description of illustrated embodiments, which proceeds with reference to accompanying drawings.

### BRIEF DESCRIPTION OF THE DRAWINGS

FIG. 1 is a flow diagram illustrating an exemplary overall method for improving robustness of a software program.

FIG. 2 is a block diagram illustrating an exemplary system for determining error tolerant execution contexts for robust execution of a software program.

FIG. 3 is a flow diagram illustrating an exemplary overall method for managing runtime heap-based memory allocations related to a program.

FIG. 4 is a block diagram illustrating an exemplary runtime system comprising a memory manager for managing a heap with approximated infinite heap semantics.

FIG. 5 is a flow diagram illustrating an exemplary method for generating an approximation of an infinite heap.

FIG. 6A is a block diagram illustrating an exemplary approximation of an infinite heap with an exemplary request being presented for allocation.

FIG. 6B is a block diagram illustrating the exemplary approximation of the infinite heap of FIG. 6A with the requested allocation having been processed by randomized allocation of the object on the heap.

FIG. 7 is a flow diagram illustrating an exemplary method for randomized allocation of memory on an approximated infinite heap.

FIG. 8 is a block diagram of an exemplary approximation of an infinite heap comprising exemplary subdivisions of object size specific pages.

FIG. 9 is a block diagram illustrating an exemplary runtime system comprising exemplary replicas of a software program, each replica having associated therewith an exemplary randomized infinite heap approximation for conducting a robust execution of the program.

FIG. 10 is a flow diagram illustrating an exemplary method of conducting a robust execution of a software program comprising execution of exemplary replicas of a software program, each replica having associated therewith an exemplary randomized infinite heap approximation.

FIG. 11 is a flow diagram illustrating an exemplary method of addressing errors related to uninitialized reads of memory locations on a heap.

FIG. 12 is a diagram illustrating an exemplary listing of pseudo code describing an algorithm for an exemplary method of memory management of an approximated infinite heap including an initialization step.

FIG. 13 is a diagram illustrating an exemplary listing of pseudo code describing an algorithm for an exemplary method of memory management of an approximated infinite heap including an memory allocation step.

FIG. 14 is a diagram illustrating a exemplary listing of pseudo code describing an algorithm for an exemplary method of memory management of an approximated infinite heap including an memory deallocation step.

FIG. 15 is a block diagram illustrating an exemplary computing environment for implementing the methods and system for achieving software robustness through variation by randomized execution contexts.

### DETAILED DESCRIPTION

### An Overall Method of Improving Software Robustness

Execution contexts in which a software program executes (e.g., the runtime system, program stack, etc.) can vary significantly and yet maintain identical execution semantics with respect to a correct execution of the program. If there is an error in a program, some of these execution contexts will result in incorrect execution of the program. For instance, if there is a buffer overrun, then writing to the memory beyond the array may overwrite other important data. Other execution contexts, however, are tolerant of such errors. For instance, if it so happens that the locations at the end of the array are not being used for other purposes by the program, no data overwrites are caused. Thus, some error tolerant execution contexts will allow programs with errors, such as buffer overruns, to execute correctly to completion despite the errors, while others do not. Based on this observation, for a given program, one exemplary method of improving software robustness is to seek an execution context in which, despite any errors, the program will terminate correctly.

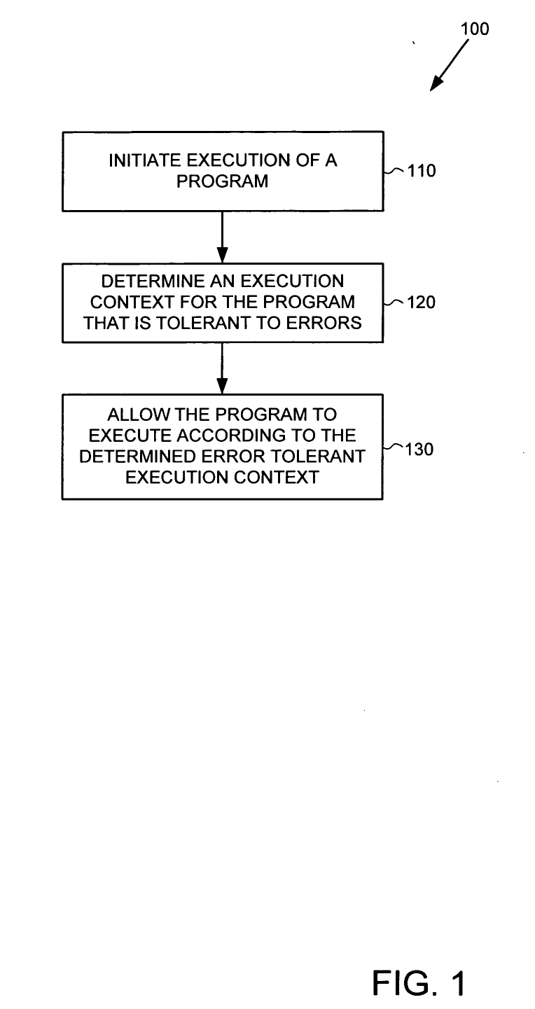

FIG. 1 describes such an overall method 100. Upon initiation (at 110) of a program's execution, at 120, an execution context that is tolerant of errors is configured, and at 130, the program is allowed to execute according to the error tolerant execution context.

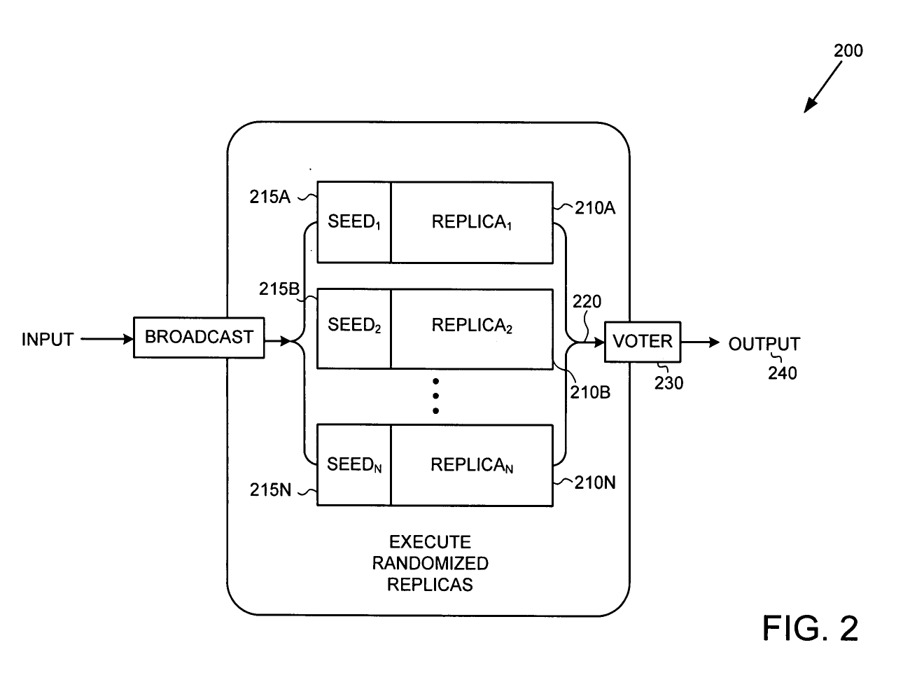

In a further step described with reference to an exemplary randomized runtime system 200 of FIG. 2, the probability of identifying an error tolerant execution context can be improved if the same program is run with multiple execution contexts. For instance, as shown in FIG. 2, N replicas, 210 A-N, are executed. The different execution contexts for these program replicas 210 A-N are generated randomly by using different randomization seeds 215 A-N, for instance. Some of these randomly generated execution contexts are error tolerant while others are not. Thus, some of the replicas 210 A-N may execute correctly while others may not. The execution contexts that preserve correctness are determined by comparing the outputs at 220 by a voter 230. The replicas 210 A-N whose outputs at 220 agree are considered correct and are, therefore, allowed to continue execution. This is so at least because the replicas have randomly generated execution contexts, thus, the likelihood that a plurality of replicas with memory errors (e.g., where a buffer overrun has corrupted other data) will have identical output can be reasoned upon based on such factors as the number of replicas, for instance. In other words, if at least two different replicas of a program executing in different randomly generated execution contexts yield identical results, it is more likely that they executed correctly. Conversely, the replicas that produce a different result are more likely to have executed with errors. Nevertheless, the agreed upon output 240 is selected by the voter 230 to carry the execution further. The result is that programs with existing errors can execute correctly to completion with no changes to the code. In this manner, the robustness of a software program can be improved without the need for identifying the program errors or fixing the same.

### Exemplary Execution Contexts

Exemplary execution contexts of a program include specific implementation details that map abstract program constructs (such as variables, heap objects, stack frames, etc.) into the concrete implementation of the program on a computer (e.g., the memory locations of the program abstractions). Thus, in this sense, both the compiler and the runtime define the execution context of a program. The compiler determines stack layouts, locations of static data, code, and field offsets, etc., whereas the runtime system determines the heap layout and location of objects on the heap, mappings of threads to processors, etc. Many of the exemplary embodiments described herein consider the part of the execution context defined by the program runtime system without the loss of generality. In particular, many of the exemplary embodiments herein describe in concrete terms how the runtime memory allocator can be used for randomizing execution contexts for achieving improved software robustness. The principles described with respect to the memory allocator can also be applied to other aspects of the execution context (e.g., things defined by the compiler, such as stack layout) and other parts of the runtime system (e.g., the thread implementation).

### an Exemplary Runtime Environment for Improved Software Robustness

One of the key components of a runtime system is a memory manager that, among other things, allocates and de-allocates memory with respect to various objects of the program during its execution. Different memory allocation schemes can be implemented by a memory manager for the same program without a change in the semantic behavior of the program's execution. Thus, there are many equivalent execution contexts (or memory allocation schemes) that will result in a correct execution. This is because, objects allocated on the heap can be allocated at any address and the program should still execute correctly. However, some allocation schemes are more robust than others. For instance, some incorrect programs write past the end of an array. For such programs, the implementation of the memory allocator can have a significant effect on correct program execution. One implementation of the memory allocator may place an important object right next to the array, so that overwriting the array corrupts the data in the important object. Another implementation may place an empty space after the array, such that writing past the end of the array does not result in any program data being overwritten. Thus, this latter implementation can effectively hide the program error and allow the program to run correctly to completion. Such buffer overruns are just one type of a memory safety error that breaks type-safety in programs written in weakly-typed languages, such as C and C++. The other examples include duplicate frees (where an object that has been freed is given back to the memory allocator to be reallocated, but is accidentally freed again by the programmer) and dangling pointers (where addresses of objects exist, but the object pointing to that address has been de-allocated).

An ideal runtime system, however, could address these memory safety errors by effectively masking them. One such exemplary ideal runtime environment would have the semantics of an infinite heap with the following exemplary properties:
All objects are allocated infinitely far from each other (conceptually, infinitely large), thus, overwriting the memory of one object can never corrupt the data of another object.
All heap memory is allocated only once and calls to Free( ) are ignored.
All metadata used by the memory allocator is in a part of memory that cannot be written by the program.
All memory locations that are not allocated to objects are filled with random values.

While such an ideal runtime system is not practical, if in fact it can be realized, programs with memory safety errors would be more likely to complete correctly than they would with any conventional runtime system implementation. In much of the existing paradigm, programs that have any memory safety violation are considered to be incorrect a priori and, as a result, they are not concerned with understanding whether the complete execution of such programs results in a desired output. For the methods described herein, an ideal runtime execution is defined as a program executing to normal termination and generating results that is equivalent to that which would be produced by the program if it were run with the ideal runtime system.

In any event, one practical approach to providing robustness to memory safety errors equivalent to that provided by the ideal runtime system is by approximating the behavior of an ideal runtime environment with infinite heap semantics.

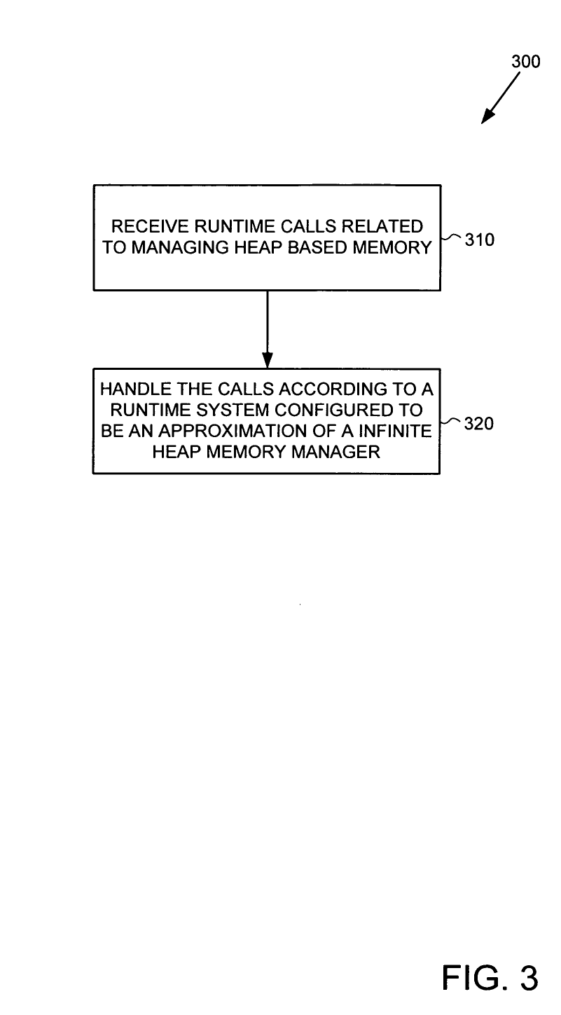

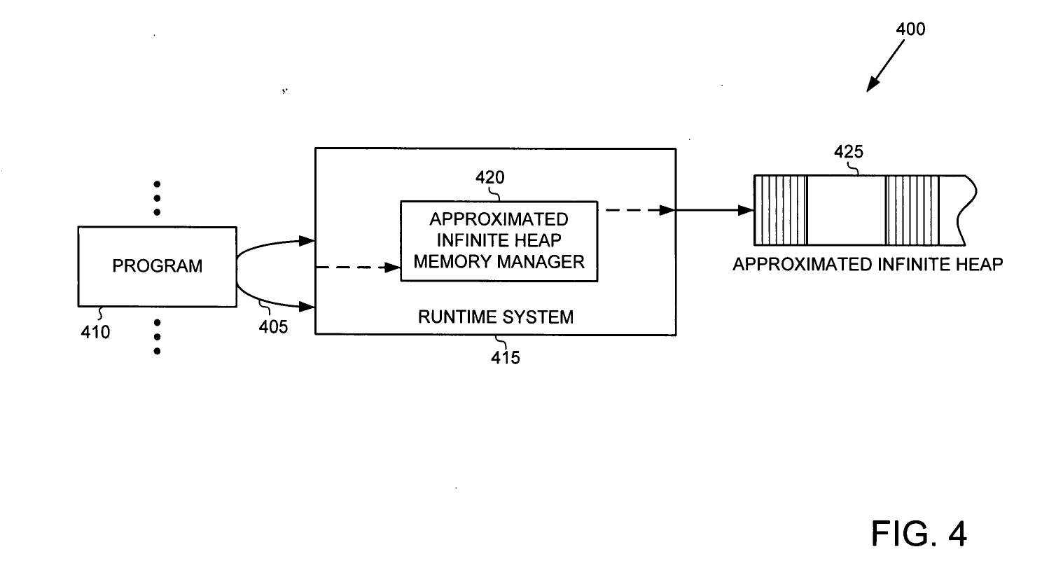

FIG. 3 describes one exemplary overall method 300 for improving robustness of software. According to the method 300, upon receiving calls (e.g., Malloc ( ), Free ( )), at 310, related to memory management, at 320, the calls are handled by a runtime system having an approximated infinite heap memory manager configured to handle an approximation of an infinite heap. FIG. 4 illustrates a runtime system 400 for implementing the method 300 of FIG. 3, for instance. Thus, memory management calls 405 from a program 410 to the runtime system 415 is handled by an approximated infinite heap memory manager 420 configured to manage an approximation of an infinite heap 425.

### Exemplary Approximation of an Infinite Heap

A memory manager having access to a truly infinite heap is impractical. However, an approximation of an infinite heap memory manager, with one or more of the characteristics described above can be made practical. For instance, in one exemplary implementation, the address space of an approximated infinite heap is defined to be an exemplary expansion factor M times the total amount of address space required by the program assuming it has perfect packing. Intuitively, the larger the expansion factor (e.g., AM), the more unallocated space exists between allocated objects and, thus, the less likely that a buffer overwrite of one object by another will occur. As a result, a larger value for the expansion factor increases the probability that a particular random execution will generate results that agree with results of an execution in an ideal runtime environment. Of course, a larger value for the exemplary expansion factor also increases the memory requirements of running the program. However, users can analytically reason about the trade-offs between increased robustness versus increased demand for memory use.

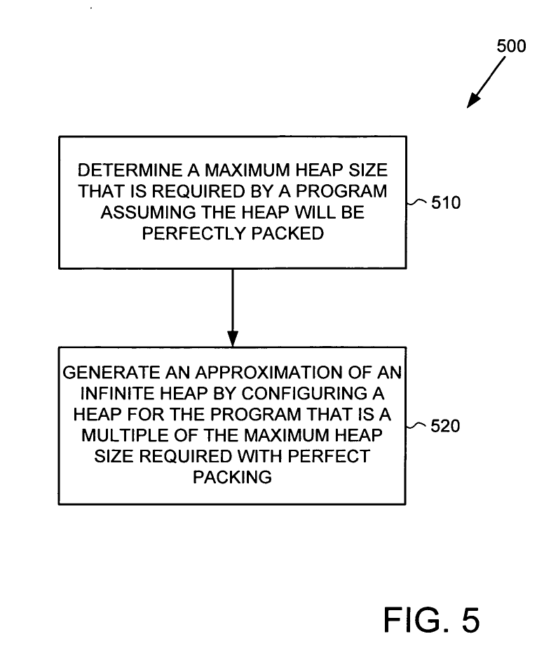

FIG. 5 further illustrates this method 500 of generating an approximated infinite heap. At 510, a maximum heap size required by a program assuming that the heap will be perfectly packed is first determined. Then at 520, an approximation of an infinite heap is determined which is a multiple (e.g., by an expansion factor Al) of the maximum heap size required by a program assuming perfect packing. The expansion factor M can be any positive number, including an integer or even a real number with a fraction. In one embodiment, the expansion factor is a variable for a call to a function that implements the behavior of an approximated infinite heap memory manager. This embodiment is described below in further detail.

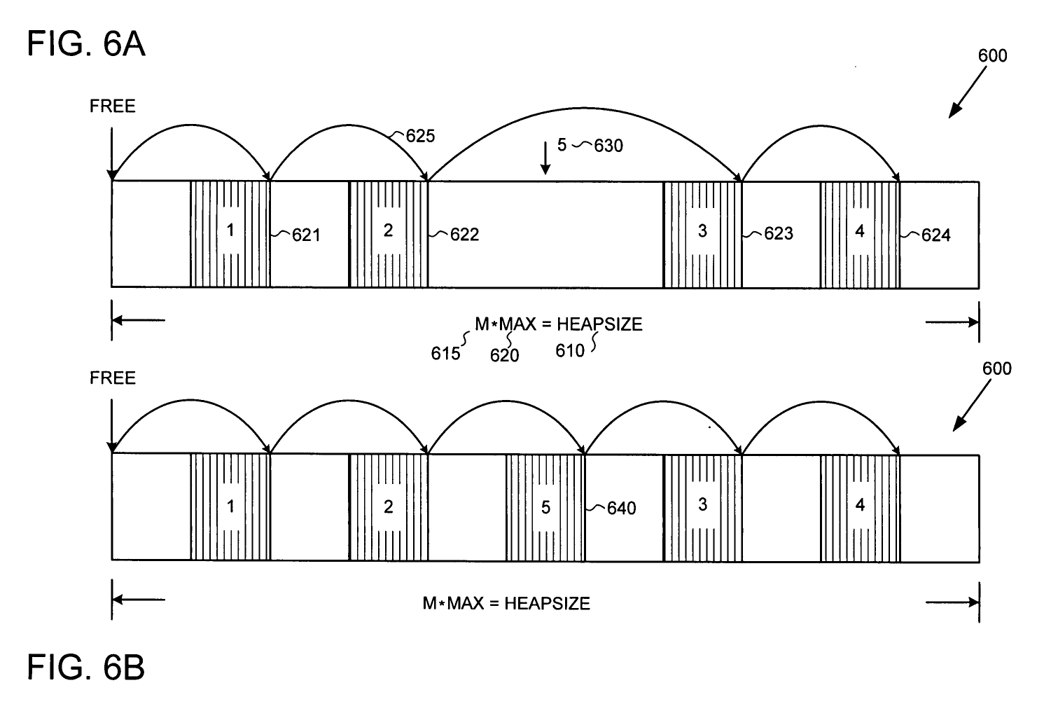

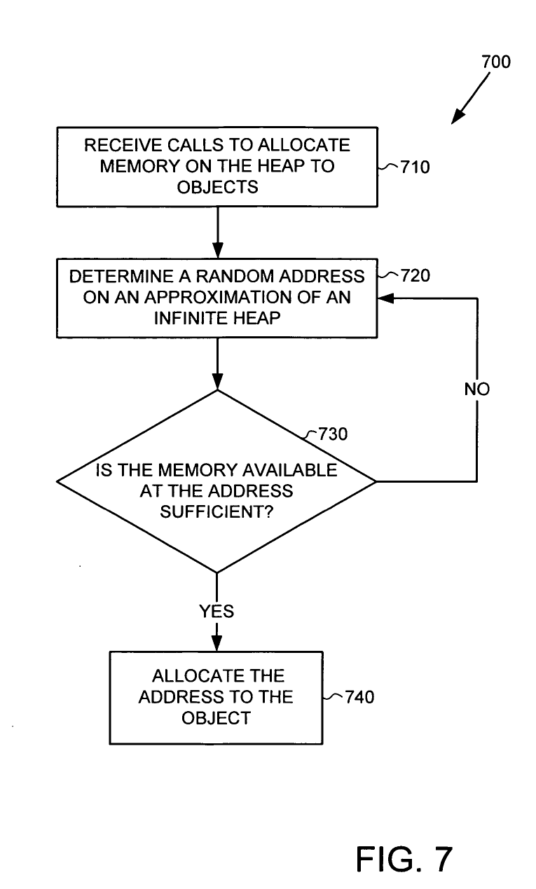

FIG. 6A illustrates one such approximation 600 of an infinite heap. The heap size 610 of this approximation 600 is a variable expansion factor M, at 615, times the total heap size (e.g., Max at 620) required by the program assuming perfect packing. Data regarding memory locations (e.g., 621-624) already allocated to objects is maintained. A free list data structure, as shown at 625, comprising a list of pointers to addresses of locations on the heap 600 that are free is also maintained. Thus, in one probability analysis, the chance of randomly allocating a new object to a memory location that interferes with a previous allocation is less than or equal to 1/M, which assumes that all objects that need to be allocated have in fact been allocated.

### Exemplary Methods of Allocating on an Approximation of an Infinite Heap

The memory manager for allocating and de-allocating objects on an approximated infinite heap, such as the one at 600, is randomized in order to improve the chances of hiding memory safety errors. FIG. 7 illustrates one approach 700 to randomized allocation. Upon receiving calls at 710 to allocate memory on the heap to an object, at 720, a random address associated with the approximated infinite heap (e.g., 600) is determined. The determination of the random address can be based on a random number seed used to generate a sequence of random numbers. Many types of random number generators are suitable. For instance, Marsaglia's multiply-with-carry random number generation algorithm is one such suitable random number generator. Once the random address is generated, at 730, if the memory space associated with the address is sufficient, at 740 that space is allocated to the object in question. If not, the process returns to 720 to probe the heap again to find another random address on the free list. In one exemplary implementation, the free list is structured in such a way that the elements of the list are sorted in address order. This allows allocations to avoid searching the entire list. FIGS. 6A-B illustrate the random allocation of an object 5 of FIG. 6A (630) at an appropriate memory address shown at 640 on the approximated infinite heap 600 as shown at FIG. 6B.

The method 700 of FIG. 7 is exemplary. Other variations are possible to randomize the allocation of heap memory. For instance, in one alternative, once a random address is first identified (e.g., as in 720 in FIG. 7), the free list is searched for the first available free list element with an address greater than the random address. If that address is not suitable, instead of generating another random address for allocation, the next available address location greater the first randomly generated address is examined for suitability. In this embodiment, the costs associated with repeatedly generating random numbers can be avoided but it is also less random.

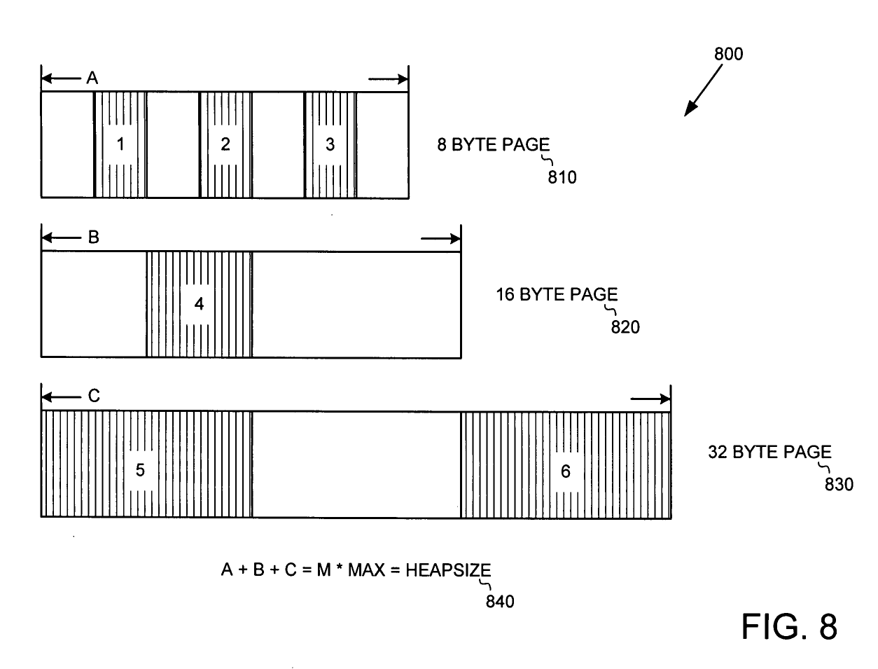

A further alternative implementation illustrated with reference to FIG. 8 has the approximated infinite heap 800 subdivided into classes of different sized objects (e.g., size 8 bytes, 16 bytes, 32 bytes, etc.). Each size class would be allocated contiguously in a set of pages (e.g., 810, 820, and 830). To allocate an object, the size requested is first mapped to a size class (e.g., one of 8 bytes, 16 bytes, 32 bytes, etc.) and a uniform random number is generated from 0 to the current number of elements allocated to the size class (minus one). The number is mapped to a specific location on a specific page (e.g., one of the sets 810, 820, and 830) and the first free location after that location is used for the allocation. An auxiliary bitmap per size class is updated to indicate the location has been allocated. The total size of the heap 840 remains a multiple M of the heap size required assuming perfect packing.

Such classification based on size of requests and allocating to different regions of memory that are size specific makes the algorithm more practical by reducing the fragmentation that is likely to result if small objects are scattered across the entire heap.

A key aspect of both strategies is the ability to characterize a runtime system configuration concisely. Thus, it is advantageous to be able to control the runtime system configuration purely through specifying a collection of parameters so that no recompilation and/or relinking are necessary to run an application with a different configuration.

When an object is allocated in a randomized runtime, the goal is to distribute the addresses of the allocations across the address space as uniformly as possible with high efficiency. While two possible methods are illustrated in detail, there are many ways to accomplish the same. For instance, either approach above could be written such that, if the random address generated already contains an object, then another random address is generated, continuing until an empty location is identified.

### Exemplary Methods of De-allocation on an Approximated Infinite Heap

In the context of method 700 of FIG. 7, when an object is freed, the memory space allocated to it is placed back in the free list (e.g., 625 of FIG. 6A) in address order, and any additional indices are updated as appropriate. Similarly, in the context of the size class based allocation described with reference to FIG. 8, when an object is freed, the associated auxiliary bitmap is updated to indicate that the memory address originally allocated to the object is now free. Any additional details would be similar to those of an equivalent implementation that does not attempt to allocate objects randomly. In an alternative implementation, objects that are request to be freed are not freed immediately, but instead it is deferred for a random duration. This buffer in duration can help corruption due to dangling pointers. However, it is important to note that, the randomization of the process of selecting an address on the free list for allocation (e.g., as described with reference to FIG. 7) itself reduces the chances that memory allocated to a recently freed object are overwritten due to dangling pointer errors. In another instance, memory associated with objects that are requested to be freed remain unallocated until a predetermined fraction of the entire address space on the heap has been allocated, and then, the memory associated with the freed objects are allocated in the first-in, first-out order.

### Exemplary Randomized Heap Memory Managers for Managing Randomly Replicated Executions of a Program

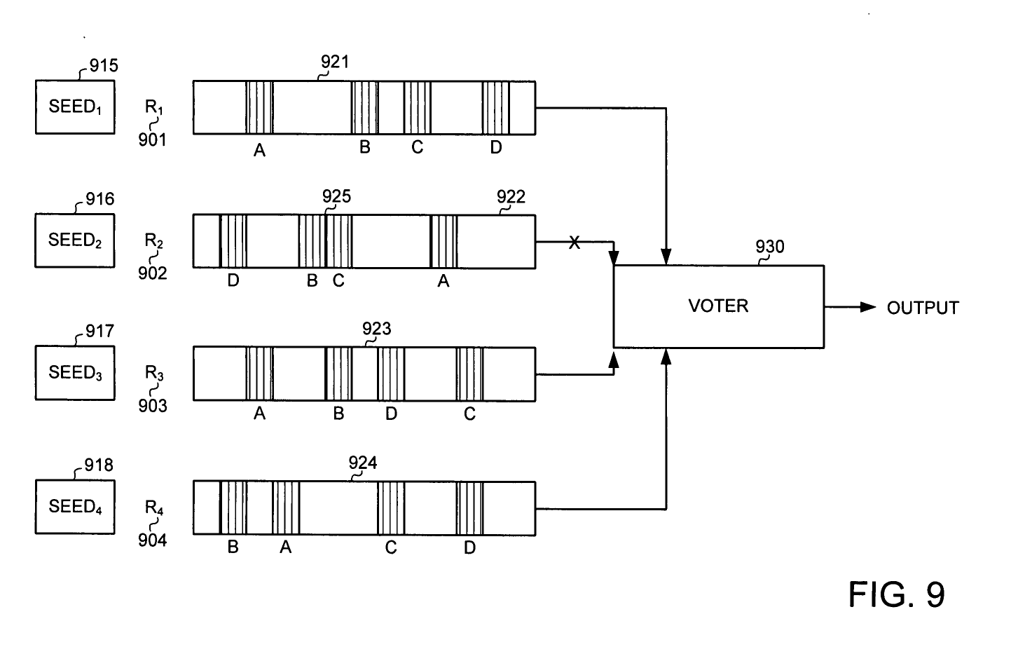

As noted above with respect to FIG. 2, by choosing to execute a plurality (e.g., some value N) of replicas of a program with execution contexts that are randomly different, it is more likely that an execution context that masks errors can be identified and used. The execution context as it relates to dynamic allocation of memory on an approximation of an infinite heap can be randomized as described above (e.g., with reference to FIGS. 7 and 8). As shown in FIG. 9, a plurality of replicas R₁-R₄ (901-904) of a program are executed each with randomized heap memory management and each are randomized according to a different seed (e.g., Seed₁-Seed₄915-918) for allocating and deallocating memory on an approximated infinite heap 921-924. By randomizing the memory management with different seeds (915-918), the different heaps 921-924 associated with each of the replicas R₁-R₄ (901-904) will likely look different as the program execution proceeds. For instance, as shown in FIG. 9, the allocation of exemplary objects A-D is randomly different on the different heaps 921-924. The allocation scheme on the heap at 922 associated with the replica R₂ at 902 shows an allocation of objects B and C at 925 that is potentially vulnerable to buffer overruns and heap meta-data overwrites. Thus, it is possible that at least one of the replicas R₁-R₄ (901-904) is likely to be corrupted.

The corrupted replica can be determined by comparing the outputs of the various replicas R₁-R₄ (901-904) at the voter 930. For instance, when the output of one replica (e.g., R₂ at 902) disagrees with the rest, that replica is more likely to be corrupted than not, therefore, it is discarded while the execution of the rest is continued. Thus, when one or more replicas have outputs that agree, the confidence that one has that the results of these executions agree with the results generated in an ideal runtime environment can be determined analytically and controlled by choosing the number of replicas N, for instance. Generally, the greater, the number of replicas, the greater the chance, that one of them is executing in an ideal runtime environment. Furthermore, the greater the number of replicas whose outputs agree, the greater the chances that they are executing correctly.

However, choosing a high number of replicas also has drawbacks. For instance, running a number of replicas, particularly simultaneously, adds to the cost of computing by putting a greater burden on the processor. Therefore, it would be better in some cases to implement the execution of the replicas on a system with multiple processors to reduce the negative impact on processing speeds. Another factor that impacts the probability of identifying an execution context that is ideal is the expansion factor M associated with generating infinite heap approximation (e.g., 420 of FIG. 4). Thus, by explicitly choosing N, the number of replicas, and M, the expansion factor for realizing an approximated infinite memory, a runtime system designer can trade memory and central processing unit usage against improved robustness of a program execution.

In one exemplary implementation, a programmer could explicitly choose the number of replicas N and the expansion factor M, and pass it on as parameters to a runtime system. In another implementation, the runtime system could choose the number of replicas N and/or the expansion factor M based on previously measured executions of the program and recorded outcomes. In another implementation, a standard value of N and M (e.g., N=3, M=2) could be used in all cases. In one exemplary implementation, the expansion factor M associated with each of the replicas for approximating their associated infinite heap need not be the same.

### Exemplary Methods of Randomized Heap Memory Managers for Managing Randomly Replicated Executions of a Program

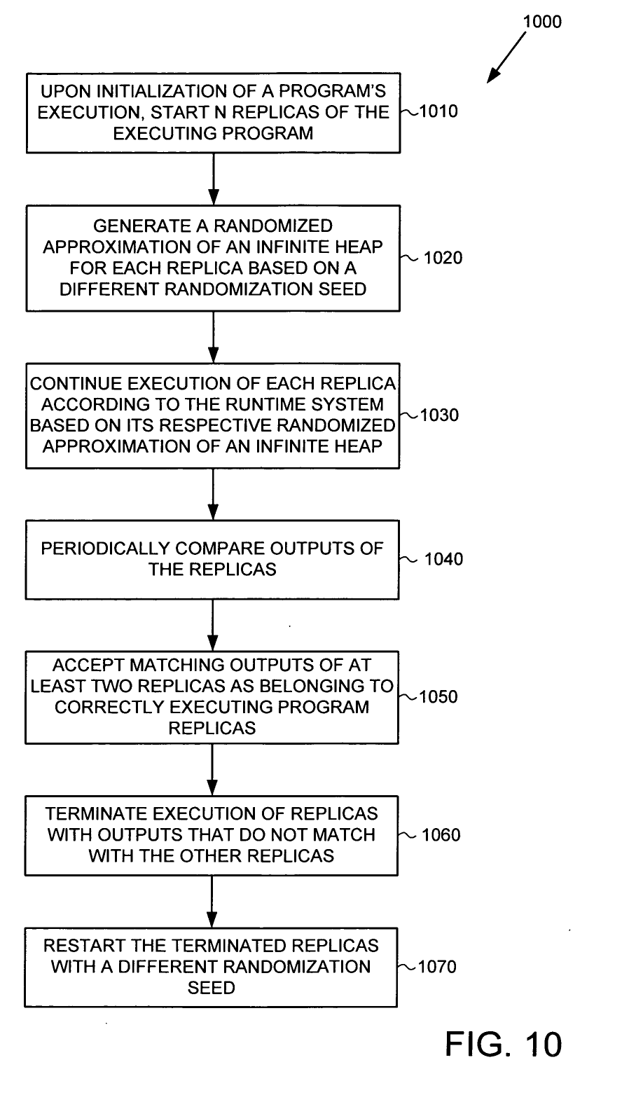

FIG. 10 illustrates an exemplary method 1000 of randomized heap memory management of a plurality of replicas of a program in a runtime system. Upon initiation of executing a program, at 1010, N different replicas of the executing program are started. At 1020, a randomized approximation of an infinite heap is generated for each of the replicas based on a different randomization seed. At 1030, the execution of each of the replicas is continued in the execution context of their respective randomized approximations of an infinite heap. At 1040, output of the various replicas is periodically compared, during I/O operations, for instance. The output streams of the different replicas (e.g., R₁-R₄ at 901-904 in FIG. 9) are connected to the checking process (e.g., Voter at 930), such that when output from the replicas are about to be flushed to a disk, the voter 930 can intercept the action and process the output before proceeding. Then at 1050, outputs of those replicas that agree are retained as correct and flushed to a disk, for instance, whereas the replicas whose outputs do not agree with any of the other replicas are terminated or repaired at 1060.

The voter 930 of FIG. 9 chooses an output agreed upon by at least two of the replicas (e.g., R₁-R₄ at 901-904 in FIG. 9) and outputs that result. Two replicas suffice, because the odds are slim that two randomized replicas with memory errors would return the same results. On the other hand, any non-agreeing replicas are more likely to have errors, and thus, are terminated. Optionally, at 1070, these replicas may be restarted with a different seed. If no replicas agree, then all are terminated. In one exemplary implementation, the matching of outputs can be computed efficiently by calculating a secure hash of the value of each page (or multiple pages) and comparing the hash. There are disadvantages to this periodic synchronization of outputs. One such disadvantage is that an erroneous replica could theoretically enter an infinite loop, which would cause the entire program to hang, because the synchronization would never occur. There are two exemplary approaches that one can take to resolve this situation. For instance, a timer can be used to terminate replicas that take too long to arrive at the barrier (e.g., voter 930 of FIG. 9), or ignore the problem. Establishing an appropriate waiting time would solve the problem of consensus in the presence of Byzantine failures, which is undecidable.

Having several replicas running with errors in deployed applications can also be addressed. Randomizing execution contexts by generating randomized infinite heaps improves the chances that at least some of the replicas are executing in an ideal runtime environment. As noted above, the drawback to this approach is the cost of running multiple replicas. Therefore, in one implementation, the randomized replicas could be run during a testing phase and when an ideal runtime environment is identified, the variables, such as the expansion factor M, associated with successful execution and the outputs of the successful execution can be used by memory managers associated with the deployed applications. Even here, the successful execution is still probabilistic. In one exemplary implementation of this approach, the application would be run in phases. In phase one the application would be run over a suite of test inputs with a large heap expansion factor M and two replicas, for instance, so that the likelihood of an ideal runtime environment execution is high. This process is repeated until the outputs of the two replicas agree. The outputs of the two replicas would be compared as above. The resulting output is highly likely to be the same as the ideal runtime environment output (and this likelihood can be determined analytically). This output is stored for use in phase two.

In phase two, smaller values of the expansion factor could be used and the resulting output can be compared against the output of the ideal runtime environment obtained in phase one. Generating multiple random instances for a given value of the expansion factor and comparing the results against the ideal runtime environment output allows us to determine the probability of an ideal runtime environment execution for a given value of the expansion factor M (over the specific test inputs used). In phase three, the value of the expansion factor, for which the desired probability of correct execution has been measured, is used for subsequent executions of the program. At this stage, with no replicas and an empirical model for the likelihood of an ideal runtime environment execution, a program implementation with predictable level of robustness at a specific level of memory overhead can be deployed.

### Exemplary Methods for Resolving Double Frees, Invalid Frees, Metadata Overwrites and Unitialized Reads

Double frees and invalid frees are addressed simply by ignoring attempts to Free( ) already free objects which are identified in a free list 625 of FIG. 6. Metadata overwrites can be addressed by segregating the heap metadata from the heap. Thus, while heap corruption caused by double frees, invalid frees and heap metadata overwrites can be addressed with certainty, the immunity from buffer overruns and dangling pointers remain probabilistic and unitialized reads remain unaddressed. An uninitialized read is a use of memory obtained from an allocation before it has been initialized by the program. If an application relies on value reads from such memory, then its behavior is unpredictable.

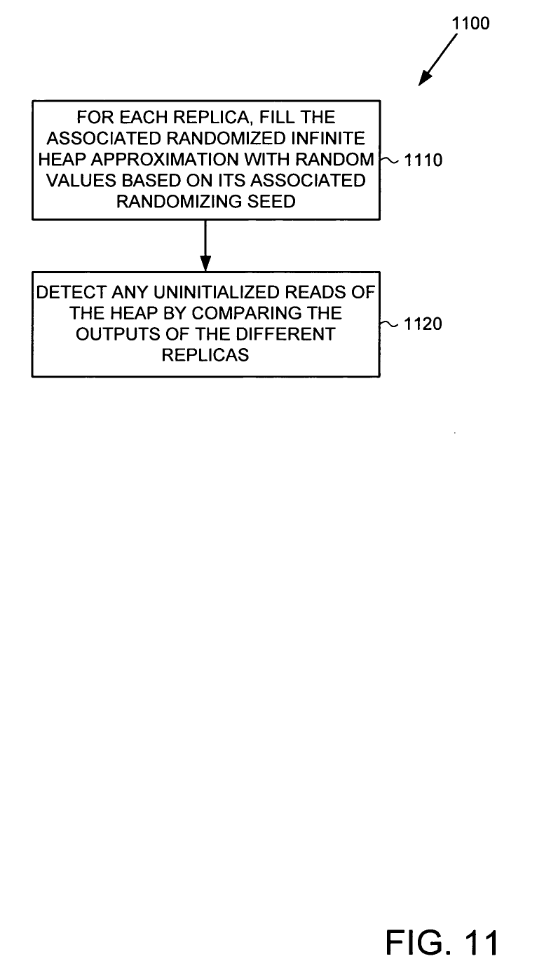

In one exemplary method 1100 of FIG. 11 for detecting uninitialized reads, at 1110, the approximated infinite heap (e.g., 921-924 in FIG. 9) associated with at least two executing replicas and every allocated memory space (e.g., A-D in FIG. 9) associated therewith are filled with random values. The uninitialized reads can then be detected at 1120 by comparing outputs of the at least two replicas. Because these values are random, and thus, likely to be different, if an uninitialized read occurs, and it in fact affects the output, it will return different results across the different replicas. Thus, the earlier criterion for accepting a replica's output as being from an ideal runtime execution, which is that outputs of at least two replicas agree, also confirms that no uninitialized reads have occurred.

In cases where uninitialized reads are not of much concern the allocated memory space may be initialized with zeros. This will not detect uninitialized memory reads by the above method but the programs are more likely to terminate.

### An Exemplary Embodiment of a Randomized Memory Manager

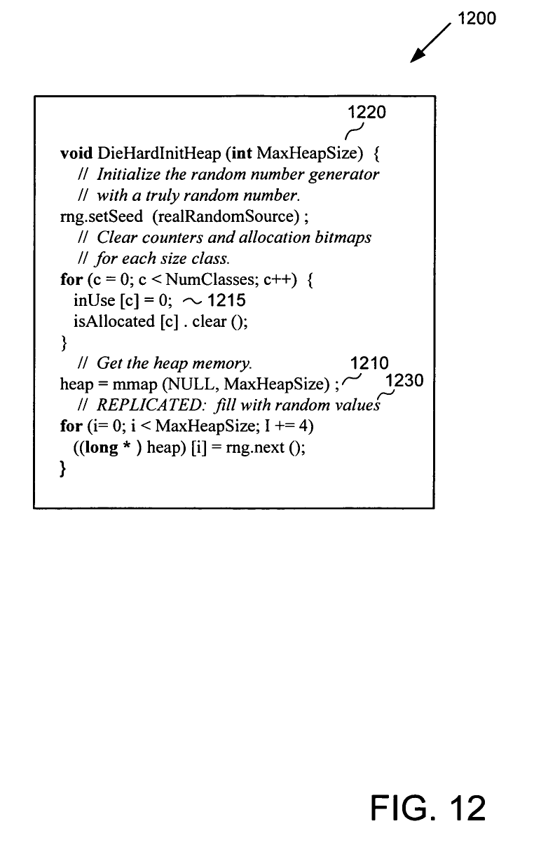

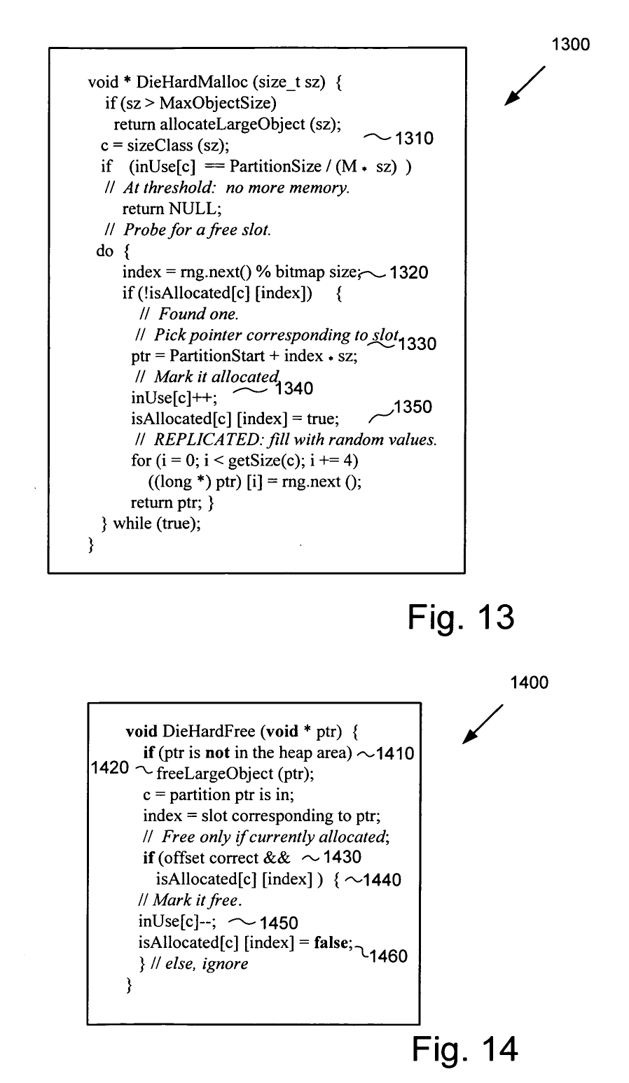

One exemplary embodiment of a randomized memory manager for managing an approximation of an infinite heap is described herein with reference to FIGS. 12-14. The randomized memory manager is described herein with reference to an algorithm that approximates the infinite heap semantics described above. The algorithm comprises an initialization operation DieHardInitHeap 1200 shown in FIG. 12, an allocation operation DieHardMalloc 1300 shown in FIG. 13 and deallocation operation DieHardFree 1400 shown in FIG. 14. These functions are implemented as functions in a memory management library and calls to these functions are redirects by library interposition of typical calls to Malloc and Free in the code of the program in question.

The initialization operation 1200 first obtains free memory from the system using mmap 1210. The heap size 1220 is a parameter to the allocator function DieHardMalloc at 1200, corresponding to the expansion factor M described above. For the replicated version, randomized memory manager (e.g., 200 in FIG. 2), then uses its random number generator to fill the heap with random values at 1230. Each replica's random number generator is seeded with a true random number. For example, the Linux function /dev/urandom is a source of true randomness. Another suitable implementation is an in-lined version of Marsaglia's multiply-with-carry random number generation algorithm, which is a fast, high-quality source of pseudo-random numbers. The heap is logically partitioned into twelve exemplary regions, one for each power-of-two size class from 8 bytes to 16 kilobytes (e.g., regions 810, 820, and 830 in FIG. 8). Also, guard pages are placed without read or write access on either end of these regions. Each region is allowed to become at most 1/M full. Optionally, larger objects are allocated directly using mmap 1210. Object requests are rounded up to the nearest power of two. Using powers of two significantly speeds allocation by allowing expensive division and modulus operations to be replaced with bit-shifting. Separate regions make the allocation algorithm more practical. If allocations were randomly spread across the entire heap area, significant fragmentation would be a certainty, because small objects would be scattered across all of the pages. Restricting each size class to its own region reduces such external fragmentation.

Another aspect of the algorithm is the total separation of heap metadata from heap objects. Many allocators store heap metadata in areas immediately adjacent to allocated objects (e.g., as “boundary tags”). A buffer overflow of just one byte past an allocated space can corrupt the heap, leading to program crashes, unpredictable behavior, or security vulnerabilities. Other allocators place such metadata at the beginning of a page, reducing but not eliminating the likelihood of corruption. Keeping all of the heap metadata separate from the heap protects it from buffer overflows. The heap metadata includes a bitmap for each heap region, where one bit always stands for one object. All bits are initially set to zero, indicating that every object is free. Additionally, the number of objects allocated to each region is tracked by (inUse) at 1215. This number is used to ensure that the number of objects does not exceed the threshold factor of 1/M in the partition.

When an application requests memory from randomized memory manager via a call to DieHardMalloc 1300 in FIG. 13, the allocator first checks to see whether the request is to a large object (e.g., larger than 16K in one implementation); if so, it uses allocateLargeObject 1310 to satisfy the request, which uses mmap and stores the address in a table for validity checking by DieHardFree 1400 in FIG. 14. Otherwise, it converts the size request into a size class (e.g., one of 8 bytes to 16 kilobytes, such as 810, 820, and 830 of FIG. 8). As long as the corresponding region is not already full, the allocator looks for space, at 1320. At 1330, the allocator picks a random number and checks to see if the slot in the appropriate partition is available. The fact that the heap can only become 1/M full bounds the expected time to search for an unused slot to 1/(1-(1/M)). For example, for M=2, the expected number of probes is two. Finally, after finding an available slot, at 1340 the allocator marks the object as allocated, increments the allocated count, and, for the replicated version, fills the object with randomized values 1350. The memory manager relies on this randomization to detect uninitialized reads, for instance, as described above.

To defend against erroneous programs, the de-allocator DieHardFree 1400 of FIG. 14 takes several steps to ensure that any object given to it is in fact valid. First, at 1410 it checks to see if the address to be freed is inside the heap area, indicating it may be a large object. Because all large objects are mmaped on demand, they lie outside of the main heap. The function freeLargeObject at 1420, checks the table to ensure that this object was indeed returned by a previous call to allocateLargeObject 1310. If so, it munmaps the object; otherwise, it ignores the request. If the address is inside the heap, memory manager checks it for validity to prevent double and invalid frees. At 1430, first, the offset of the address from the start of its region (for the given size class) must be a multiple of the object size. Second, at 1440, the object must be currently marked as allocated. If both of these conditions hold, memory manager finally resets the bit corresponding to the object location in the bitmap at 1450 and at 1460 decrements the count of allocated objects for this region.

### Exemplary Computing Environment

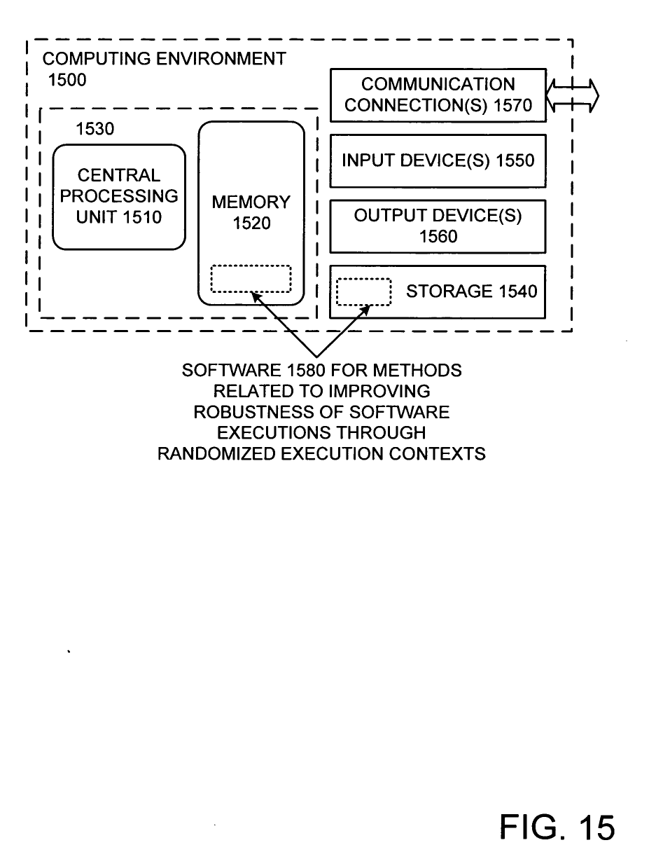

FIG. 15 and the following discussion are intended to provide a brief, general description of an exemplary computing environment in which the disclosed technology may be implemented. Although not required, the disclosed technology, including methods for achieving software robustness through randomizing execution contexts, was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 15 illustrates a generalized example of a suitable computing environment 1500 in which described embodiments may be implemented. The computing environment 1500 is not intended to suggest any limitation as to scope of use or functionality of the technology, as the present technology may be implemented in diverse general-purpose or special-purpose computing environments.

With reference to FIG. 15, the computing environment 1500 includes at least one central processing unit 1510 and memory 1520. In FIG. 15, this most basic configuration 1530 is included within a dashed line. The central processing unit 1510 executes computer-executable instructions and may be a real or a virtual processor. In a multi-processing system, multiple processing units execute computer-executable instructions to increase processing power. The memory 1520 may be volatile memory (e.g., registers, cache, RAM), non-volatile memory (e.g., ROM, EEPROM, flash memory, etc.), or some combination of the two. The memory 1520 stores software 1580 implementing the described methods for improving software robustness through randomized execution contexts. A computing environment may have additional features. For example, the computing environment 1500 includes storage 1540, one or more input devices 1550, one or more output devices 1560, and one or more communication connections 1570. An interconnection mechanism (not shown), such as a bus, a controller, or a network, interconnects the components of the computing environment 1500. Typically, operating system software (not shown) provides an operating environment for other software executing in the computing environment 1500, and coordinates activities of the components of the computing environment 1500.

The storage 1540 may be removable or non-removable, and includes magnetic disks, magnetic tapes or cassettes, CD-ROMs, CD-RWs, DVDs, or any other medium which can be used to store information and which can be accessed within the computing environment 1500. The storage 1540 stores instructions for the software 1580 implementing methods described herein for improving software robustness through randomized execution contexts.

The input device(s) 1550 may be a touch input device, such as a keyboard, mouse, pen or trackball, a voice input device, a scanning device, or another device, that provides input to the computing environment 1500. For audio, the input device(s) 1550 may be a sound card or similar device that accepts audio input in analog or digital form, or a CD-ROM reader that provides audio samples to the computing environment 1500. The output device(s) 1560 may be a display, printer, speaker, CD-writer, or another device that provides output from the computing environment 1500.

The communication connection(s) 1570 enable communication over a communication medium to another computing entity. The communication medium conveys information, such as computer-executable instructions or other data in a modulated data signal, for instance.

Computer-readable media are any available media that can be accessed within a computing environment 1500. By way of example, and not limitation, with the computing environment 1500, computer-readable media include memory 1520, storage 1540, communication media (not shown), and combinations of any of the above.

In view of the many possible embodiments to which the principles of the disclosed technology may be applied, it should be recognized that the illustrated embodiments are only preferred examples of the technology and should not be taken as limiting the scope of the following claims. We therefore claim all that comes within the scope and spirit of these claims. The disclosed technology is directed toward novel and unobvious features and aspects of the embodiments of the system and methods described herein. The disclosed features and aspects of the embodiments can be used alone or in various novel and unobvious combinations and sub-combinations with one another.

For instance, although the operations of the disclosed methods are described in a particular, sequential order for convenient presentation, it should be understood that this manner of description encompasses rearrangements, unless a particular ordering is required by specific language set forth below. For example, operations described sequentially may in some cases be rearranged or performed concurrently. Some of the steps may be eliminated or other steps added. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Having described and illustrated the principles of our technology with reference to the illustrated embodiments, it will be recognized that the illustrated embodiments can be modified in arrangement and detail without departing from such principles.

We claim:

1. A computer-implemented method for improving the robustness of a software program execution, the method comprising:
initiating execution of the program;
determining an execution context for the program that is error tolerant; and
allowing the program to execute according to the error tolerant execution context.

2. The method of claim 1 wherein determining the execution context that is error tolerant comprises configuring an error tolerant stack layout.

3. The method of claim 1 wherein determining the execution context that is error tolerant comprises configuring an error tolerant runtime heap layout.

4. The method of claim 1 wherein determining the execution context for the program that is error tolerant comprises:
initiating execution of at least one replica of the program;
generating correspondingly randomized execution contexts for the program and each of the at least one replica of the program;
periodically comparing the outputs of the program and at least one replica of the program; and
accepting the outputs that agree as outputs of a correctly executing program.

5. The method of claim 4 wherein periodically comparing the outputs of the program and the at least one replica comprises comparing the outputs during input/output operations.

6. A computer implemented method for randomized management of runtime heap-based memory associated with an executing software program, the method comprising:
receiving a call related to managing runtime heap-based memory; and
handling the call in accordance with a runtime system configured to manage a heap which is an approximation of an infinite heap.

7. The method of claim 6 further comprising, generating the approximation of the infinite heap.

8. The method of claim 7 wherein generating the approximation of the infinite heap comprises:
determining a maximum heap size required by the executing program assuming perfect packing of the heap; and
generating the approximation of the infinite heap as a multiple of the maximum heap size assuming perfect packing.

9. The method of claim 8 wherein the multiple is at least two.

10. The method of claim 8 wherein randomized management of the runtime heap-based memory comprises randomized allocation of memory space on the approximation of the infinite heap to objects associated with the software program.

11. The method of claim 10 wherein the randomized allocation comprises:
generating a random number that corresponds to some address associated with the approximation of the infinite heap;
on a free list comprising a listing of addresses indicative of unallocated locations on the approximation of the infinite heap, identifying the randomly generated address; and
if memory space associated with the location indicated by the identified randomly generated address is sufficient for the object, allocating the location to the object.

12. The method of claim 11 further comprising repeating the generating step, if the location indicated by the randomly generated address is insufficient for the object.

13. The method of claim 8 wherein generating the approximation of the infinite heap as a multiple of the maximum heap size assuming perfect packing comprises:
subdividing the approximation of the infinite heap into a plurality of page sets, each page set comprising memory elements of a specific size class which are reserved for allocation of objects of the corresponding size.

14. The method of claim 13 wherein randomized management of the heap-based memory comprises randomized allocation of memory space to objects on the approximation of the infinite heap, further wherein randomized allocation comprises:
mapping memory allocation requests to a size class;
generating a random number between zero and a current number of memory elements in the page set corresponding to the size class;
mapping the random number to a specific location; and
allocating the object to a free location on the page set after the location associated with the random number.

15. A computer implemented method for improving robustness of a software program execution, the method comprising:
initiating execution of a plurality of replicas of the software program;
generating approximations of infinite heaps correspondingly associated with each of the replicas, wherein each replica has associated therewith a different randomization seed for randomizing allocation of the memory on their respective approximation of the infinite heap;
periodically comparing data outputs of at least some of the replicas; and
accepting as an output of correctly executing programs, the output agreed upon by at least two of the plurality of replicas.

16. The method of claim 15 wherein generating the approximations of the infinite heap comprises:
determining a maximum heap size required by the executing program assuming perfect packing of the heap; and
generating the approximation of the infinite heap by expanding the maximum heap size assuming perfect packing by an expansion factor that is a multiple of the maximum heap size assuming perfect packing.

17. The method of claim 16 wherein a number of replicas and the expansion factors are received as input parameters to a function call for performing the method of claim 16.

18. The method of claim 15 further comprising terminating execution of those replicas whose outputs do not agree with any of the other replicas and starting execution of another replica in their place with a different randomization seed.

19. The method of claim 15 further comprising filling locations within each of the approximations of the infinite heap associated with the replicas with values that are randomly generated based on their respective randomization seeds.

20. The method of claim 15 wherein at least some of the replicas are executed on different processors.

21. The runtime system for heap-based memory management related to execution of a software program, the system comprising a memory manager programmed to be operable for:
generating a heap to be associated with the software program that approximates infinite heap semantics;
receiving requests for allocating heap memory from the program; and
in response to receiving the requests, allocating randomly selected locations on the approximated infinite heap.

22. The runtime system of claim 21 wherein generating the heap that approximates infinite heap semantics comprises generating a heap that is a multiple of a heap size required for the program assuming perfect packing.

23. The runtime system of claim 21 further operable for:
initiating execution of a plurality of replicas of the software program;
generating heaps that approximate infinite heap semantics to be correspondingly associated with each of the replicas, wherein each replica has associated therewith a different randomization seed for randomizing allocation of the memory on their respective approximation of the infinite heap;
receiving requests for allocating heap memory from the program;
in response to the received requests, allocating randomly selected locations on the approximated infinite heap;
periodically comparing data outputs of at least some of the replicas; and
accepting as an output of correctly executing programs, the output agreed upon by at least two of the plurality of replicas.

24. The runtime system of claim 23 further comprising filling locations within each of the executing program replicas with values randomly generated based on their respective randomization seeds.

25. At least one computer-readable medium useful in conjunction with a computer, the computer comprising at least one processor and memory, the computer-readable medium having stored thereon computer executable instructions for improving robustness of a software program execution method, the method comprising:
initiating execution of a plurality of replicas of the software program;
generating heaps correspondingly associated with each of the replicas having semantics that are approximations of those of an infinite heap,
filling the heaps of at least some of the replicas with random values generated using a different randomization seed;
in response to requests for memory allocation by the replicas, allocating memory on the respective approximations of the infinite heap;
periodically comparing data outputs of at least some of the replicas; and
accepting as an output of correctly executing programs, the output agreed upon by at least two of the plurality of replicas.
